(19) United States
(12) Patent Application Publication
(10) Pub. No.: US 2011/0048407 A1
(43) Pub. Date: Mar. 3, 2011

(54) Solar Collectors

(76) Inventor: Peter Martin Broatch, Weymouth (GB)

(21) Appl. No.: 12/518,092

(22) PCT Filed: Dec. 20, 2007
(86) PCT No.: PCT/GB07/04918

§ 371 Date: Jun. 5, 2009

(30) Foreign Application Priority Data
Dec. 23, 2006 (GB) 0625927.9

(51) Int. Cl. E04D 13/18; B23P 15/26; F24J 2/36

(52) U.S. Cl. 126/622; 29/890.033; 126/624

(57) ABSTRACT

A solar collector is constructed on a support structure (such as a roof (14)) that has a plurality of side-by-side channels (16) (for example formed between roof battens (20)), using a length of an elongate web (26) of flexible material that is formed with a plurality of generally parallel passageways for a thermal transfer fluid extending in the longitudinal direction of the web and spaced apart across the width of the web. A first run (26c) of the web is laid along a first of the channels of the support structure so that one face of the web faces out of said first channel. The web is split longitudinally between at least one adjacent pair of the passageways adjacent and beyond the end of said first run and is curved so that the web enters a second of the channels of the support structure. A second run (26d) of the web can then be laid along the second channel so that said one face of the web faces into said second channel.

This invention relates to solar collectors and methods of constructing them.

Solar collectors are used to collect the energy of incident solar radiation and convert it to a form in which it can conveniently be used, transmitted and/or stored. For example, solar energy can be directly converted to electricity by photovoltaic cells; it can be used to heat water which can then be used directly, for example to bathe in; or it can be used to heat a thermal transfer fluid which can in turn be used to heat water for consumption or can be supplied to a space heating system.

One form of solar collector is described in patent document EP1332322A and is made up from sections of metal pipe on a longitudinal metal fin. The sections are joined together in runs between battens extending along a roof, and at the end of each run the pipe is plumbed to the pipe in the next run or to a header or manifold. Once the sections have been installed, the roof is tiled over the sections with tiles having a high transmissivity to solar radiation. In use, the pipework is filled with water or some other thermal transfer fluid which is heated by solar radiation. The thermal transfer fluid can then be drawn off as hot water or can be circulated around a heating system or to a heat exchanger and back to the solar collector.

Installation of the collector of EP1332322A entails a large amount of plumbing work with a consequent risk of leaks, and is laborious and therefore expensive. Also, the majority of the solar radiation is collected by the fin and needs to be conducted through the fin to the pipe and thence to the thermal transfer fluid. As a result, the efficiency of energy collection leaves room for improvement.

An aim of a first aspect of the present invention, or at least of specific embodiments of it, is to provide a method of construction of a solar collector which is quick and simple and results in a highly efficient solar collector.

In accordance with the first aspect of the invention, there is provided a method of construction of a solar collector on a support structure (such as a roof) that has a plurality of side-by-side channels (for example formed between roof battens). The method employs a length of an elongate web of flexible material that is formed with a plurality of generally parallel passageways for a thermal transfer fluid extending in the longitudinal direction of the web and spaced apart across the width of the web. The method comprises the steps of: laying a first run of the web along a fust of the channels of the support structure so that one face of the web faces out of said first channel; splitting the web longitudinally between at least one adjacent pair of the passageways adjacent and beyond the end of said first run; curving the split web so that the web enters a second of the channels of the support structure; and laying a second run of the web along the second channel so that said one face of the web faces into said second channel. This aspect of the invention alternatively extends to the cases where the channels are formed at the same time as or after the web has been laid.

The solar collector of the first aspect of the invention is far easier to install and less likely to leak than the collector of EP1332322A because the only plumbing work that is required is at the ends of the web, and a single web, if sufficiently long, can be used for a complete roof face. The provision of a plurality of passageways for the thermal transfer fluid along each run, rather than a single pipe as in EP1332322A, improves the efficiency of energy collection. The thickness of the battens that are typically used for solar collectors of this general type, and therefore the depth of the channels is relatively small, typically 25 mm, and therefore the space available for turning the multi-passageway web at the end of a run is restricted. However, the splitting of the web between passageways at the curve at the end of a run enables the passageways to be curved smoothly without kinking in the space available, as will be appreciated from the following detailed description. Meanwhile, the formation of the passageways as a web along the runs facilitates a neat and effective arrangement of the passageways and simplifies installation.

It may be remarked that patent document CA 1172532 describes a solar collector employing an elongate web of flexible material that is formed with a plurality of generally parallel passageways for a thermal transfer fluid extending in the longitudinal direction of the web and spaced apart across the width of the web. The web is laid out as a plurality of runs within a frame. At the turns between adjacent runs, the web is split longitudinally between adjacent pairs of the passageways. However, the web is laid out so that each face of the web faces in the same direction for all of its runs. As a result, at each turn, the passageways have different curvatures, and the passageway that lies closest to itself between adjacent runs is bent extremely tightly at the turn, with a consequent risk that it will kink and therefore block or considerably restrict the flow of the thermal transfer fluid.

It may also be remarked that patent document U.S. Pat. No. 4,823,771 describes a solar collector for heating a pool or spa employing a number of multi-passageway webs. Each web has first and second generally parallel runs that extend over the ground from and to first and second manifolds respectively. At the other end of each run (i.e. at a region half-way long the web), the passageways are not connected together as a web so that the passageways can be curved. Since the curved region is always half-way along the web, the web is apparently manufactured in this form, rather than splits being formed in the web during laying of the solar collector on the ground. By contrast, in accordance with the first aspect of the invention, the web may be provided without the splits being pre-formed, and the split or splits are formed during installation of the solar collector on the support structure. The web can therefore be used with any length of run and with runs that vary in length from one run to the next. Indeed, it is a preferred feature of the first aspect of the invention that the splitting step is performed after at least the majority of the first run has been laid. Accordingly, the installer can readily see where they need to split the web, without needing to take measurements of the length of the run.

In order to take up little space at the curve, in the splitting step, the web is preferably also split longitudinally between at least one other adjacent pair of the passageways adjacent and beyond the end of said first run, and more preferably between each adjacent pair of the passageways adjacent and beyond the end of said first run. Preferably, the splits have similar lengths.

The web is preferably formed to facilitate splitting of the web longitudinally between adjacent pairs of the passageways, for example with grooves to produce lines of weakness.

The first and second channels of the supporting structure accommodating the first and second runs of the web would typically be adjacent each other. In this case, in order to facilitate a smooth curve between the runs, the length of each longitudinal split is at least about one-and-a-half times the pitch of the channels.

Preferably, an edge of the web has a protruding formation, and the method further includes the step of fixing the protruding formation to the support structure. The protruding formation may be a simple flange which can be stapled or nailed to the supporting structure. Alternatively, the protruding formation may be shaped to interlock with a complementary formation of the support structure. It will be appreciated from the following description that if the edge with the protruding formation is laid uppermost on one run of the web (so that the web hangs from it), it will also be uppermost on the next run of the web. Therefore, there is no need to provide a similar protruding formation on the opposite edge of the web. Indeed for reasons of cost, the opposite edge of the web is preferably devoid of a symmetrical, interlocking, protruding formation. The protruding formation may be formed with an elongate ridge arranged, along the first run of the web, to face out of said first channel and to contact and seal with glazing tiles overlying the web and the support structure. In this case, the web is preferably also formed with a further elongate ridge symmetrically disposed with respect to the first-mentioned ridge and arranged, along the second run of the web, to face out of said second channel to contact and seal with the glazing tiles.

In the case where the channels of the support structure are substantially narrower than the width of the web, the method may further include the step of splitting the web to remove at least one of the passageways from the web. It is therefore unnecessary to manufacture a large range of sizes of the web. Instead, one or a few sizes may be manufactured, and a particular size can then be adjusted at the time of installation. Furthermore, in the case where one of the first and second channels is substantially narrower than the other of the first and second channels and is substantially narrower than the width of the web, the method may further include the step of splitting the web to remove at least one of the passageways from the run of the web that extends along said one channel. A single web can therefore be used with different width channels on the same support structure. In both these cases, if the web has the protruding formation described above, the removed passageway or passageways are preferably removed from the edge of the web opposite the edge having the protruding formation.

Of course, the web may be formed into more than two runs, and the method may therefore further include the steps of: splitting the web between at least one adjacent pair of the passageways adjacent and beyond the end of said second run; curving the split web so that the web enters a third of the channels of the support structure; laying a third run of the web along the third channel so that said one face of the web faces out of said third channel. Indeed, the web may be formed into sufficient runs so as to cover substantially the whole of a face of the support structure.

The method preferably further comprises the step of connecting the opposite ends of each passageway to an inlet manifold and an outlet manifold for the thermal transfer fluid.

A second aspect of the invention provides a solar collector constructed by the method of the first aspect of the invention.

A third aspect of the invention provides a building having a roof provided with a solar collector according to the second aspect of the invention.

A fourth aspect of the invention provides an elongate web for use in the method of the first aspect of the invention, wherein the web is made of flexible material, the web is formed with a plurality of generally parallel passageways for a thermal transfer fluid extending in the longitudinal direction of the web and spaced apart across the width of the web, one edge of the web has a protruding formation for affixing the web to a support structure, and the opposite edge of the web is devoid of a symmetrical, protruding formation. Preferably, the protruding formation is shaped to interlock with a complementary formation of the support structure, and the opposite edge of the web is devoid of a symmetrical, interlocking, protruding formation.

A fifth aspect of the present invention provides a solar collector system comprising a support structure and elongate web of flexible material (for example extruded from plastics or synthetic rubber material) that is supported by the support structure and has a plurality of runs, which may be of different lengths, extending across the support structure, the web being formed with a plurality of generally parallel passageways for a thermal transfer fluid extending in the longitudinal direction of the web and spaced apart across the width of the web so that solar energy incident on the structure can be absorbed by the web to heat the thermal transfer fluid in the web, the web extending integrally from one to another of the runs of the web at a return portion, and at the return portion at least one longitudinal split being formed between an adjacent pair of the passageways.

The solar collector system of the fifth aspect of the invention may be provided with many of the features of the other aspects of the invention described above.

Specific examples and embodiments of the present invention will now be described, purely by way of example, with reference to the accompanying drawings, in which:

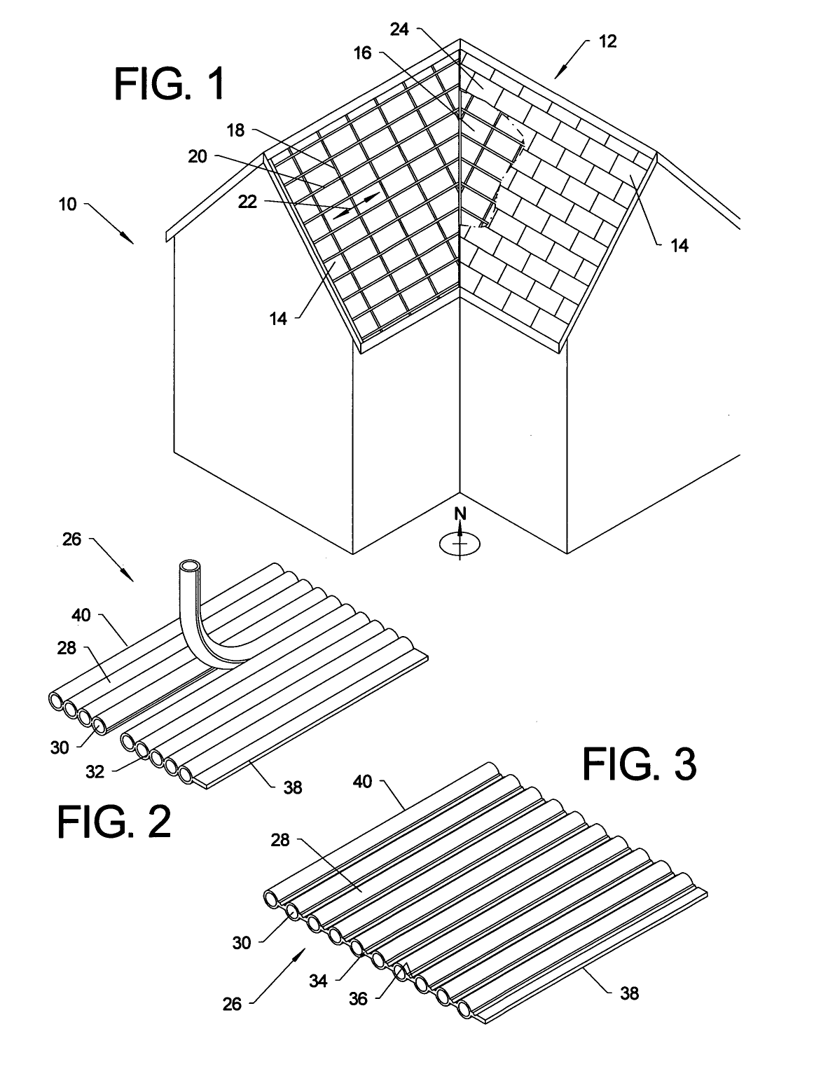

FIG. 1 is an isometric view of a building, to which the embodiments of the invention may be installed, with a portion of the tiling of the roof removed;

FIG. 2 is an isometric view of one form of web that may be used in the embodiments of the invention;

FIG. 3 is an isometric view of another form of web that may be used in the embodiments of the invention;

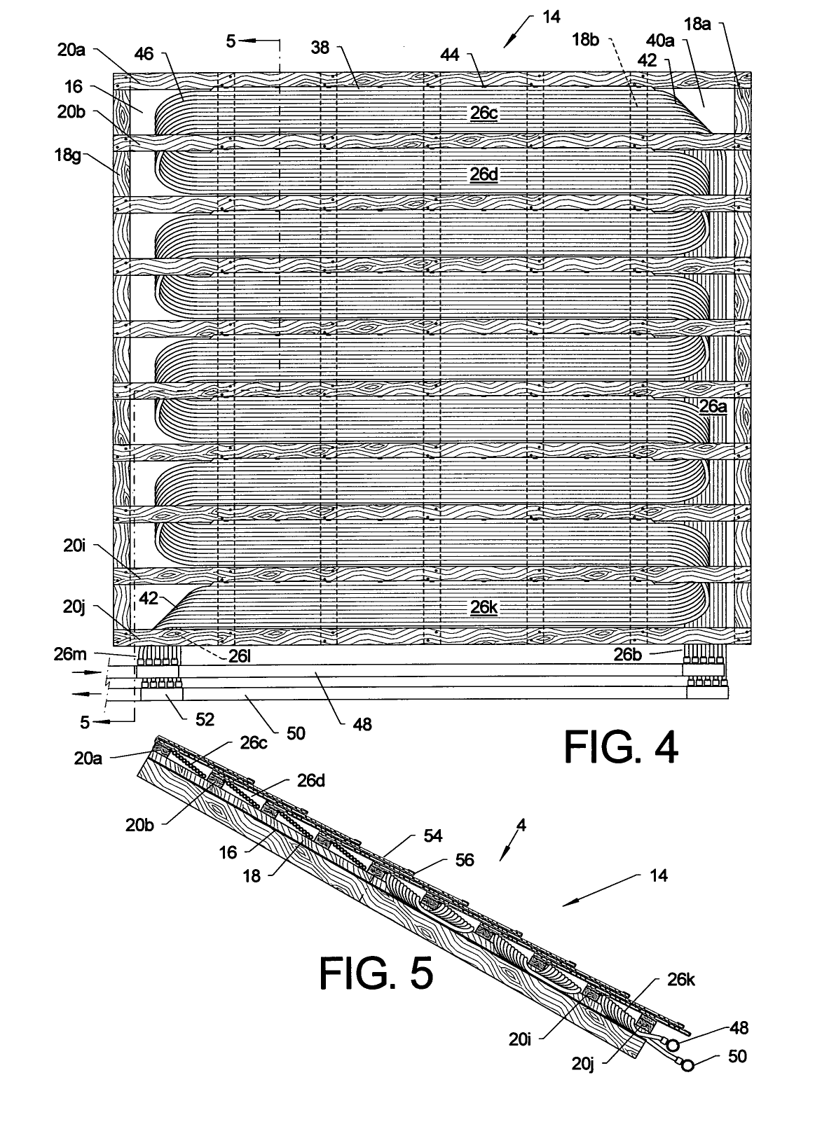

FIG. 4 is a face view of a roof in the direction 4 shown in FIG. 5, before fitting of its tiles, to which an embodiment of solar collector is fitted;

FIG. 5 is a sectioned side view, taken along the section line 5-5 shown in FIG. 4;

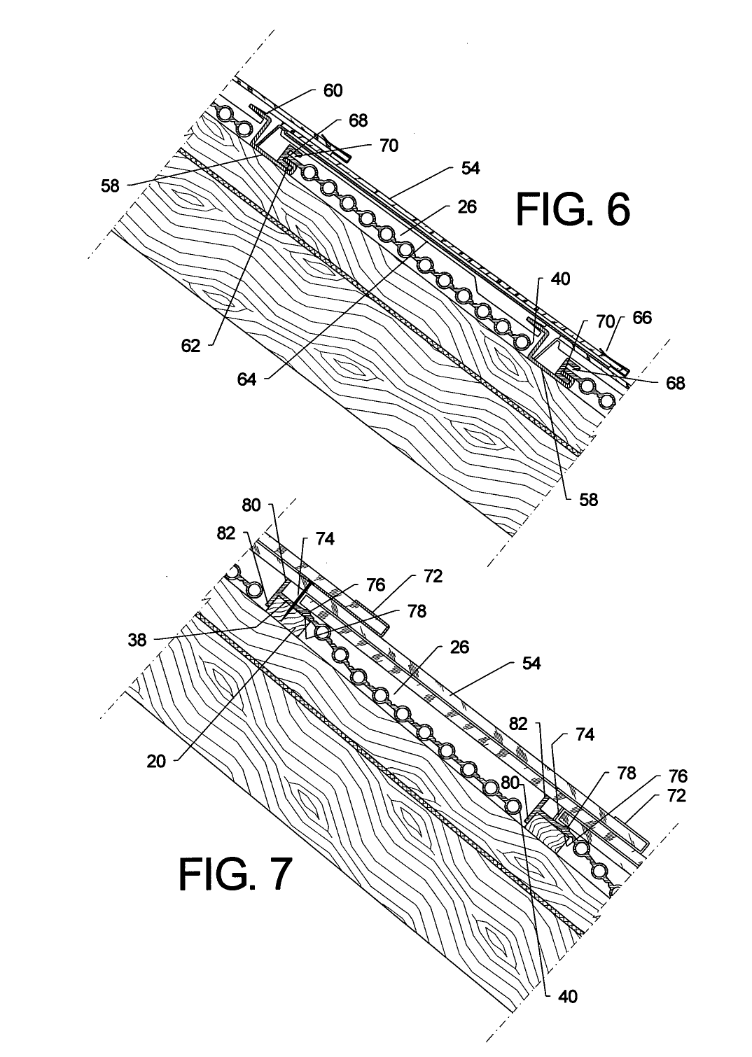

FIG. 6 is a sectioned side view of a roof fitted with another embodiment of solar collector;

FIG. 7 is a sectioned side view of a roof fitted with a further embodiment of solar collector; and

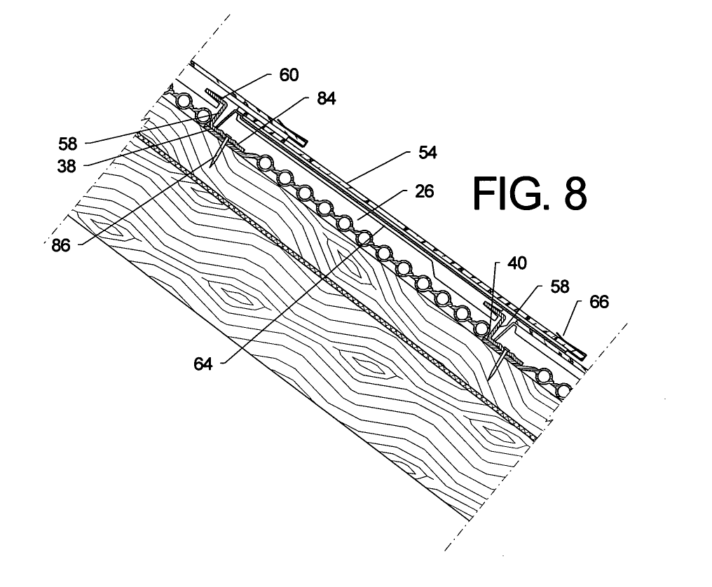

FIG. 8 is a sectioned side view showing a modification to the embodiment of FIG. 6.

Referring to FIG. 1, a building 10 has a pitched roof 12, and, in the Northern Hemisphere, solar collectors are installed in the roof faces 14 that face generally southerly between about south-east and south-west. The roof faces 14 are formed in a conventional way from rafters (not shown) covered by a layer or layers 16 of weatherproofing and thermally-insulating material. Spaced-apart wooden counterbattens 18 extending in the direction of slope of the roof faces 14 are fixed over the layer 16, and spaced-apart horizontal wooden battens 20 are fixed over the counterbattens 18. A solar collector system (not shown in FIG. 1) is then installed in the horizontal channels 22 formed between adjacent battens 20. The roof faces 14 are then tiled with tiles 24 made of a material with a high transmissivity to solar radiation, such as glass. It should be noted from FIG. 1 that, due to the inclined join between the roof faces 14, the lengths of the channels 22 formed in each roof face 14 vary.

The solar collector system that is installed in the roof faces 14 employs a web 26, examples of short lengths of which are shown in FIGS. 2 and 3. Each web 26 is extruded from a flexible synthetic rubber material such as ethylene propylene diene monomer (EPDM) rubber. Each web 26 is formed as a series of cylinders 28 interlinked side-by-side so as to provide a series of parallel passageways 30. In the examples, each web 26 has ten cylinders 28 and ten passageways 30, but webs 26 with other numbers (two or more, more preferably three or more, and even more preferably several) of cylinders 28 and passageways 30 may be employed. In the examples, the cylinders are shown as being circular, but they may be of other shapes such a square or oval. In the example of FIG. 2, the cylinders 28 slightly overlap so that they are interlinked by thin portions 32 of the synthetic rubber material, along which the material can readily be cut or even torn so as to separate one cylinder from the next, as shown. In the example of FIG. 3, the cylinders 28 are spaced apart slightly and interconnected by thin sub-web portions 34, each formed with a groove 36 to provide a line of weakness along which the synthetic rubber material can likewise readily be cut or even torn so as to separate one cylinder from the next. Along one edge of each web 26, an integral protruding flange 38 is formed, whereas the opposite edge 40 is devoid of any such flange. The web 26 is preferably supplied to an installation site in long lengths of, for example, 50 or 100 metres wound on a drum or reel.

One example of installation of the web 26 on a simple rectangular roof face 14 will now be described with reference to FIGS. 4 and 5. The web 26 may be installed at the same time as, or after, fitting of the battens 20, the latter method requiring threading of the web 26 beneath the battens 20. The former method will be described.

First, the uppermost batten 20a is secured to the counterbattens 18. Then a run 26a of the web 26 is laid extending upwardly from its end 26b below the lowermost batten 20j and in the channel 40a between the rightmost pair of counterbattens 18a,18b, with the web flange 38 to the left. Shortly before the run 26a reaches the uppermost batten 20a, splits 42 are formed in the web 26 between each of the adjacent pairs of cylinders 28, and the web 26 is folded over itself to the left. The splits 42 enable each cylinder 28 to follow a smooth quarter-circular path at the fold without kinking, and the web flange 38 becomes uppermost. The web 26 is then laid as a run 26c to the left below the uppermost batten 20a, and the web flange 38 is secured to the uppermost batten 20a by suitable means, such as staples 44. Shortly before the run 26b reaches the leftmost counterbatten 18g, splits 46 are formed in the web 26 between each of the adjacent pairs of cylinders 28, and the web 26 is folded under itself, downwardly and to the right. The splits 46 enable each cylinder 28 to follow a smooth semi-circular path at the fold without kinking, and the web flange 38 again becomes uppermost. The uppermost-but-one batten 20b is then secured to the counterbattens 18, and the web 26 is then laid as a run 26d to the left below the uppermost-but-one batten 20b, and the web flange 38 is secured to the uppermost-but-one batten 20b. The procedure is continued until the last main run 26k of the web 26 is laid under the lowermost-but-one batten 20i and secured to it. Shortly before the last main run 26k reaches the leftmost counterbatten 18g, splits 42 are formed in the web 26 between each of the adjacent pairs of cylinders 28, and the web 26 is folded under itself and downwardly. The splits 42 enable each cylinder 28 to follow a smooth quarter-circular path at the fold without kinking. The web 26 then extends downwardly as a short run 26l and is cut from the remainder of the supply of web 26 to form an end 26m, and the lowermost batten 20j is then secured to the counterbattens 18.

The end runs 26b,26l of the web 26 are then connected to inlet and outlet pipes 48,50 at manifolds 52. Various connection schemes may be employed. In the example shown, at each end of the web 26, the cylinders 28 are split from each other for a short distance; the passageways 30 are alternately connected to the inlet pipe 48 and the outlet pipe 50; and each passageway 30 is connected at one end to the inlet pipe 48 and at the other end to the outlet pipe 50.

Once the web 26 has been installed, the roof face 14 is tiled using glass tiles 54 held in place by tile hanger brackets 56 secured to the battens 20. Each tile 54 has a length of about 2½ times the pitch of the battens 20.

Various modifications may be made to the example of the invention described above with reference to FIGS. 4 and 5. For example, instead of using the web 26 for the runs 26a, 26l, the inlet and/or outlet pipes 48,50 may be arranged to be connected by manifolds directly to the ends of the first and last horizontal runs 26c,26k of the web 26. Although FIG. 4 shows a rectangular roof face 14, the web 26 may be fitted to a non-rectangular roof face, as shown in FIG. 1, with each run of the web 26 being sized to fit the space available. The web flange may be left in place along the whole length of the web, or, as shown in FIG. 4, it may be trimmed off except along the horizontal runs 26c-26k of the web 26.

A modified embodiment will now be described with reference to FIG. 6, in which features in common with the embodiment of FIGS. 4 and 5 have been given identical reference numerals.

Instead of the wooden battens 20 described above, battens 58 are used that are pressed from sheet metal. Each batten 58 provides upper and lower flanges 60,62 extending along the batten 58 and pointing upwardly in the direction of the roof slope. The glass tiles 54 are held in place by elongate link members 64. Each link member 64 is fitted to the upper flange 60 of one batten 58 and extends upwardly to rest on the next batten 58 in the upwards direction. Each link member 64 is positioned underneath the gap between two adjacent glass tiles 54 in the same course and provides a rain-guiding channel so that any rain passing through the gap is guided to exit above a tile 54 in the course below. The lower corners of the tiles 54 are held by clips 66 at the lower ends of the link members. The rain guiding channels enable the length of the glass tiles 54 to be reduced to about 1¼ times the pitch of the battens 58. Apart from the lower flanges 62, this batten 58 and link member 64 system is known and marketed under the mark Nu-Lok® by Nu-lok Roofing Systems Pty Ltd, AU-5000, and Nu-lok Roofing Systems (UK) Ltd, GB-HA4 7TL.

The lower flanges 62 on the battens 58 are provided as a means for attaching the web 26 without the need to use staples or the like. Accordingly, instead of having a plain flange 38, one edge of the web 26 is formed in cross-section in the shape of a letter “E” with the web extending away from the centre limb of the E. Accordingly, two channels 68,70 are formed between the centre limb and the upper and lower limbs of the E. Along one run of the web 26, the flange 62 of one batten 58 engages in one 68 of the channels 68,70, and along the next adjacent run of the web 26 the flange 62 of the next batten 58 engages in the other 70 of the channels 68,70. Again, the web 26 is devoid of any corresponding formation along the opposite edge 40 of the web.

Another modified embodiment will now be described with reference to FIG. 7, again in which features in common with the previously-described embodiments have been given identical reference numerals.

In the case of FIG. 7, the glass tiles 54 are held in place by short glass hanger brackets 72 that are secured to wooden battens 20 by screws 74. Each bracket 72 engages the lower edge of a first tile 54 about half-way across its width, and its screw 74 (a) passes through a hole in the bracket 72, (b) passes through the gap between second and third tiles 54 beneath the first tile 54, (c) passes over the top edge of a fourth tile 54 beneath the second and third tiles 54, (d) passes through the flange 38 of the web 26 immediately beneath the fourth tile 54 and (e) is screwed into the batten 20 from which the web 26 hangs. The screws 74 therefore serve not only to hold the tiles 54 in place but also to secure the web 26 to the battens 20. The web flange 38 is formed with integral ridges 76,78 on its two faces. Along one run of the web 26, one 76 of the ridges 76,78 engages the glass tiles 54 to seal to them, whilst along the next run of the web 26, the other 78 of the ridges engages the glass tiles 54 to seal to them. The web flange 38 is also formed at its distal end as a “T” shape, and the arms 80,82 of the T engage the tiles in the next course up also to seal to them. The seals provided by the ridges 76,78 and arms 80,82 of the T shape serve to trap the air that is beneath the tiles 54 so that heat is not lost by convection. The seals also cushion the tiles 54 so as to reduce the risk of damage to the tiles 54 during installation. Yet again, the web 26 is devoid of any corresponding formations along the opposite edge 40 of the web.

A modification to the arrangement of FIG. 6 is shown in FIG. 8. In this case, one edge of the web 26 is formed with a wide plain flange 38 which is fitted underneath the lower portion 84 of the metal batten 58 and fixed in place by the same fixing means (such as nails or screws 86) that are used to fix the metal battens 58 to the counterbattens 18. The other edge 40 of the web 26 is devoid of such a flange 38.

It should be noted that the embodiments of the invention has been described above purely by way of example and that many modifications and developments may be made thereto within the scope of the present invention.

1. A method of construction of a solar collector on a support structure (14) that has, or is to be formed with, a plurality of side-by-side channels (16), the method employing a length of an elongate web (26) of flexible material that is formed with a plurality of generally parallel passageways (30) for a thermal transfer fluid extending in the longitudinal direction of the web and spaced apart across the width of the web, and the method comprising the steps of:
laying a first run (26c) of the web along a, or a site for a, first of the channels of the support structure so that one face of the web will face out of said first channel;
splitting the web longitudinally between at least one adjacent pair of the passageways adjacent and beyond the end of said first run;
curving the split web so that the web enters a, or a site for a, second of the channels of the support structure; and
laying a second run (26d) of the web along the, or the site for the, second channel so that said one face of the web will face into said second channel.

2. A method as claimed in claim 1, wherein the splitting step is performed after at least the majority of the first run has been laid.

3-7. (canceled)

8. A method as claimed in claim 1, wherein the, or the sites for the, first and second channels of the supporting structure are adjacent each other.

9. A method as claimed in claim 1, wherein an edge of the web has a protruding formation (36; 68,70; 80,82), and further including the step of fixing the protruding formation to the support structure.

10. A method as claimed in claim 9, wherein the protruding formation (68,70) is shaped to interlock with a complementary formation (62) of the support structure.

11. A method as claimed in claim 10, wherein the opposite edge of the web is devoid of a symmetrical, interlocking, protruding formation.

12. A method as claimed in claim 9, wherein the protruding formation is formed with an elongate ridge (76,80) arranged, along the first run of the web, to face out of said first channel and to contact and seal with glazing tiles (54) overlying the web and the support structure.

13. A method as claimed in claim 12, wherein the web is formed with a further elongate ridge (78,82) symmetrically disposed with respect to the first-mentioned ridge and arranged, along the second run of the web, to face out of said second channel to contact and seal with the glazing tiles.

14. A method as claimed in claim 1, wherein the channels are substantially narrower than the width of the web, and further including the step of splitting the web to remove at least one of the passageways from the web.

15. A method as claimed in claim 1, wherein one of the first and second channels is, or will be, substantially narrower than the other of the first and second channels and is substantially narrower than the width of the web, and further including the step of splitting the web to remove at least one of the passageways from the run of the web that will extend along said one channel.

16. (canceled)

17. A method as claimed in claim 1, further including the steps of:
splitting the web between at least one adjacent pair of the passageways adjacent and beyond the end of said second run;
curving the split web so that the web enters a, or a site for a, third of the channels of the support structure;
laying a third run (26e) of the web along the third channel so that said one face of the web will face out of said third channel.

18-20. (canceled)

21. A method as claimed in claim 1, wherein the support structure is a roof (12), and the channels are formed between battens (20a-i) extending along the roof, and further including the step of tiling the roof over the web with tiles (54) having a high transmissivity to solar radiation, and wherein the tiles are secured to the roof by means (58,74,86) which serve also to secure the web to the roof.

22-23. (canceled)

24. An elongate web (26) for use in a method of construction of a solar collector on a support structure (14), wherein the web is made of flexible material, the web is formed with a plurality of generally parallel passageways (32) for a thermal transfer fluid extending in the longitudinal direction of the web and spaced apart across the width of the web, one edge of the web has a protruding formation (36;68,70) for affixing the web to a support structure (12), and the opposite edge of the web is devoid of a symmetrical, protruding formation.

25. An elongate web as claimed in claim 24, wherein said protruding formation (68,70) is shaped to interlock with a complementary formation (62) of the support structure, and the opposite edge of the web is devoid of a symmetrical, interlocking, protruding formation.

26. A solar collector system comprising a support structure (12) and elongate web (26) of flexible material that is supported by the support structure and has a plurality of runs (26c-k) extending across the support structure, the web being formed with a plurality of generally parallel passageways (30) for a thermal transfer fluid extending in the longitudinal direction of the web and spaced apart across the width of the web so that solar energy incident on the structure can be absorbed by the web to heat the thermal transfer fluid in the web, the web extending integrally from one to another of the runs of the web at a return portion, and at the return portion at least one longitudinal split being formed between an adjacent pair of the passageways.

27. A solar collection system as claimed in claim 26, wherein at least two of the runs are of different lengths.

28-32. (canceled)

33. A solar collector system as claimed in claim 26, wherein an edge of the web has a protruding formation (38; 68,70; 80,82) by which the web is affixed to the support structure.

34. A solar collector system as claimed in claim 33, wherein the protruding formation (68,70) is shaped to interlock with a complementary formation of the support structure.

35. (canceled)

36. A solar collector system as claimed in claim 33, wherein the protruding formation is formed with an elongate ridge (76,80) arranged, along a run of the web, to face away from the support structure and to contact and seal with glazing tiles (54) overlying the web and the support structure.

37. A solar collector system as claimed in claim 36, wherein the web is formed with a further elongate ridge (78,82) symmetrically disposed with respect to the first-mentioned ridge and arranged, along a run of the web, to face the support structure, but arranged, along the next run of the web, to contact and seal with the glazing tiles.

38-39. (canceled)
